(19) United States
(12) Patent Application Publication
(10) Pub. No.: US 2020/0322048 A1
(43) Pub. Date: Oct. 8, 2020

(54) Optical Wireless Communication Network For Aircraft

(71) Applicant: Airbus Operations GmbH, Hamburg (DE)

(72) Inventors: Erhard Bassow, Hamburg (DE); Stefan Schulz, Hamburg (DE)

(73) Assignee: Airbus Operations GmbH, Hamburg (DE)

(21) Appl. No.: 16/834,213

(22) Filed: Mar. 30, 2020

(30) Foreign Application Priority Data
Apr. 5, 2019 (DE) 10 2019 204 911.7

(51) Int. Cl. H04B 10/114; H04W 88/16; B64D 11/00

(52) U.S. Cl. CPC H04B 10/1143; B64D 2203/00; B64D 11/0015; H04W 88/16

(57) ABSTRACT

An optical wireless communication network includes a gateway router and a large number of optical network nodes. The gateway router includes a controllable light source, a photodetector and a modulation/demodulation apparatus coupled to the controllable light source and the photodetector. Each of the large number of optical network nodes respectively includes an optical signal transmission path extending between two optical network interfaces of the optical network node, at least one beam splitter arranged in the optical signal transmission path, and an optical network access point that is coupled to an optical access interface of the beam splitter.

### FIELD OF THE INVENTION

The invention relates to an optical wireless communication network (“visible/non-visible light communication”) for use in aircraft as well as a method for optical wireless communication in an aircraft.

### BACKGROUND OF THE INVENTION

Optical wireless communication offers a fast and economical alternative to signal transmission via modulated electromagnetic radio waves. Visible light, or light in the near-infrared range with an electromagnetic spectrum of, for example, between 100 THz and 1500 THz, is used as optical carrier for data transmission for optical wireless communication (“Visible/Non-visible Wireless Optical Link Communication”). Modulated light is used here for digital data information. The intensity and/or phase of the light generated by a light source, an LED for example, can be time-modulated in order to encode data in a light signal. A photodetector receives the modulated light signal which is decoded in order to recover the transmitted information. The light source functions in this way as a transmitter, and the photodetector as a receiver. Conventional LEDs that are also used for illumination purposes can be used for optical wireless communication, since the modulation frequency is many times what the human eye can still perceive as brightness or colour variation.

Data communication rates of more than 100 Mbit/s can be achieved through the use of high-performance LEDs making use of various multiplexing techniques—and the data communication rate can even be raised to 100 Gbit/s through a parallelization of the data transmission with multiple light sources or by means of various optical wavelengths transmitted in parallel. In aircraft in particular the ability to transmit digital data within a passenger cabin to end devices of passengers, crew and/or of the maintenance personnel is of interest, due to the ubiquitous prevalence of personal electron devices. Conventional passenger aircraft use wired and/or wireless radio networks such as mobile telephony networks or networks in accordance with IEEE 802.11 in order to enable passengers to connect to an aircraft network and to access digital content of a flight entertainment programme on the Internet or on other external networks.

In contrast to wireless radio networks, optical wireless communication offers the advantage of not generating any electromagnetic interferences (EMI) that could have effects on navigation systems or other electronic components on board the aircraft. Equally, the reception and transmission quality of the wireless radio signals can be impaired as a result of the large number of passengers on board the aircraft who would like to connect to the aircraft network simultaneously. The data transmission capacity of radio-network-based networks finally approaches a saturation value. The spectral range of optical wireless transmission that is available, being more than 2000 times greater, can overcome these bandwidth and capacity restrictions.

Documents WO 2009/132877 A1, DE 101 07538 B4 and US 2014/0226983 A1 disclose exemplary optical wireless communication networks for use in aircraft.

### BRIEF SUMMARY OF THE INVENTION

Aspects of the invention relate to finding improved solutions for the use of optical wireless communication networks in aircraft which can increase the reliability and stability of the data connections and simplify the implementation of the network components.

According to a first aspect of the invention, an optical wireless communication network comprises a gateway router and a large number of optical network nodes. The gateway router comprises a controllable light source, a photodetector and a modulation/demodulation apparatus coupled to the controllable light source and the photodetector. Each of the large number of optical network nodes respectively comprises a wireless optical signal transmission path extending between two optical network interfaces of the optical network node, at least one beam splitter arranged in the optical signal transmission path, and an optical network access point that is coupled to an optical access interface of the beam splitter.

According to a second aspect of the invention, an aircraft comprises an optical wireless communication network according to the first aspect of the invention. In some forms of embodiment, the optical network access points of the large number of optical network nodes can be installed in passenger service units or cladding panels of a passenger cabin of the aircraft. In some forms of embodiment, at least two of the large number of optical network nodes are coupled to one another via optical free-space transmission paths to form a bidirectional network connection, and the optical free-space transmission paths extend through cavities of interior cladding elements of the passenger cabin of the aircraft.

According to a third aspect of the invention, a method for optical wireless communication in an aircraft comprises the steps of forming a bidirectional optical network connection via an optical free-space transmission path between a gateway router that comprises a controllable light source, a photodetector and a modulation/demodulation apparatus coupled to the controllable light source and the photodetector, and a first of two optical network interfaces of a first of a large number of optical network nodes, of passing the bidirectional optical network connection via an optical signal transmission path in the first of a large number of optical network nodes from the first of the two optical network interfaces to a second of the two optical network interfaces, and of branching, through a beam splitter arranged in the optical signal transmission path, of the bidirectional optical network connection to an optical network access point that is coupled to an optical access interface of the beam splitter. In some forms of embodiment the method can additionally comprise the step of forming a bidirectional optical network connection via an optical free-space transmission path between the first and the second optical network interfaces of the first of a large number of optical network nodes and an optical network interface of a second of the large number of optical network nodes.

An important idea of the invention consists in not only employing free-space data transmission paths between individual network nodes, but of passing the free-space data transmission paths through the individual network nodes. Optical beam splitters that enable network branches without a conversion of the received light signals into the electronic domain and back having to take place between the network nodes are employed for this purpose within the network nodes.

A particular advantage in the solutions according to these aspects of the invention consists in that a significant increase in the data transmission rate can be achieved for applications and services in a data communication network in an aircraft. The robustness and security against interference of the communication connections can be increased in an advantageous manner through the continuous free-space data transmission paths. Existing subsystems can also be maintained with the network architecture according to the invention.

Through the use of purely optical free-space data transmission paths, and the passage of said paths through the individual network nodes, electrical cabling can be avoided in an advantageous manner with a corresponding saving in weight. In addition, the entire network architecture can easily be extended in a modular manner through the end-to-end optical configuration of the backbone connections. Equally, a redundancy that is advantageous for the stability and security against failure of the network can very easily be realized through the end-to-end optical free-space data transmission paths through the use of different light sources, different spectral transmission frequencies or through the construction of spatially different transmission paths.

Optical wireless communication is characterized by the avoidance of electromagnetic interference (EMI), which could interfere with other electrical circuits as a result of electromagnetic radiation or electromagnetic induction. In addition, optical network connections can easily be interrupted with optically opaque elements, which can increase the security against eavesdropping by third parties in an advantageous manner in comparison with radio networks. Important components of an optical wireless communication system, such as controllable light sources and photodetectors, can moreover be manufactured economically. Such components also feature only a low energy consumption and heat generation when operating with, at the same time, a long service life and low servicing requirements.

Advantageous designs and developments emerge from the further subsidiary claims as well as from the description with reference to the figures.

According to an embodiment of the optical wireless communication network, the optical network access points can each comprise an optical signal converter that is coupled to the optical access interface of the beam splitter, and a system of a controllable light source and a photo detector coupled to the optical signal converter.

According to an embodiment of the optical wireless communication network, the beam splitter can comprise a beam splitter component selected from the group of beam splitter plate, beam splitter cube, pentagon beam splitter, pellicle beam splitter and Köster prism.

According to an embodiment of the optical wireless communication network, at least two at a time of the large number of optical network nodes can be coupled to one another via optical free-space transmission paths to construct a bidirectional network connection. In the same way, in some further forms of embodiment of the optical wireless communication network, the gateway router can be coupled via an optical free-space transmission path to a first of the two optical network interfaces of one of the large number of optical network nodes to construct a bidirectional network connection.

According to an embodiment of the optical wireless communication network, at least one of the large number of optical network nodes can comprise at least two beam splitters arranged in the optical signal transmission path. A first of the at least two beam splitters here is coupled via an optical access interface to the optical network access point. A second of the at least two beam splitters can be coupled via an optical network bifurcation interface of the beam splitter to a further of the large number of optical network nodes or to a gateway router.

According to an embodiment of the optical wireless communication network, the optical wireless communication network can further comprise a network server that is coupled to the gateway router via a wireless radio network or a wired communication interface. This network server can, in some forms of embodiment, be designed to couple the gateway router to an external network, for example the Internet.

According to an embodiment of the optical wireless communication network, the optical wireless communication network can be designed with a full duplex ring topology or in a meshed full duplex topology, which means that the large number of optical network nodes are coupled to one another optically in a full duplex ring topology or in a meshed full duplex topology.

The above designs and developments can be combined with one another in any way, where meaningful. Further possible designs, developments and implementations of the invention comprise combinations, even when not referred to explicitly, of features of the invention described above or below with reference to the exemplary embodiments. In particular here, the expert will also add individual aspects as improvements or extensions to the respective basic form of the present invention.

### BRIEF DESCRIPTION OF THE DRAWINGS

The present invention is explained below in more detail with reference to the exemplary embodiments given in the schematic figures. Here:

FIG. 1 shows a schematic block diagram of an optical wireless communication network according to an embodiment of the invention;

FIG. 2 shows a schematic illustration of an aircraft with an optical wireless communication network arranged in the interior of the aircraft according to a further embodiment of the invention;

FIG. 3 shows a schematic block diagram of a variant of a network node of an optical wireless communication network according to another embodiment of the invention;

FIG. 4 shows a schematic block diagram of a periscope module for use in an optical wireless communication network according to yet another embodiment of the invention; and

FIG. 5 shows a flow diagram of a method for optical wireless communication in an aircraft according to an aspect of the invention.

### DETAILED DESCRIPTION

The appended figures should convey a further understanding of the forms of embodiment of the invention. They illustrate forms of embodiment, and serve, in connection with the description, for the explanation of principles and concepts of the invention. Other forms of embodiment, and many of the said advantages, emerge in the light of the drawings. The elements of the drawings are not necessarily shown true-to-scale. Terminology that indicates directions, such as “top”, “bottom”, “left”, “right”, “above”, “below”, “horizontal”, “vertical”, “front”, “rear” and similar statements are only used for explanatory purposes, and do not limit the generality to specific designs as in the figures.

Elements, features and components in the drawings that are the same, have the same function or the same effect are each given the same reference codes, unless otherwise stated.

Reference is made in the following description to optical wireless communication, abbreviated to V/NVLC (“visible/non-visible wireless light communications”). In general terms, optical wireless communication uses visible or non-visible light, for example between 100 THz and 1500 THz, as an optical carrier for data transmission. Modulated light is used here for digital data information. The intensity, phase and/or frequency of the light generated by a light source, for example a laser, an OLED, an AMOLED or another controllable, electroluminescent light source can be time-modulated in order to encode data in a light signal. The modulated light contains the content of the information or digital character strings to be transmitted.

A receiving module, for example a photodetector, receives the modulated light signal which is decoded/demodulated in order to recover the transmitted information. The light source functions in this way as a transmitter, and the photodetector as a receiver.

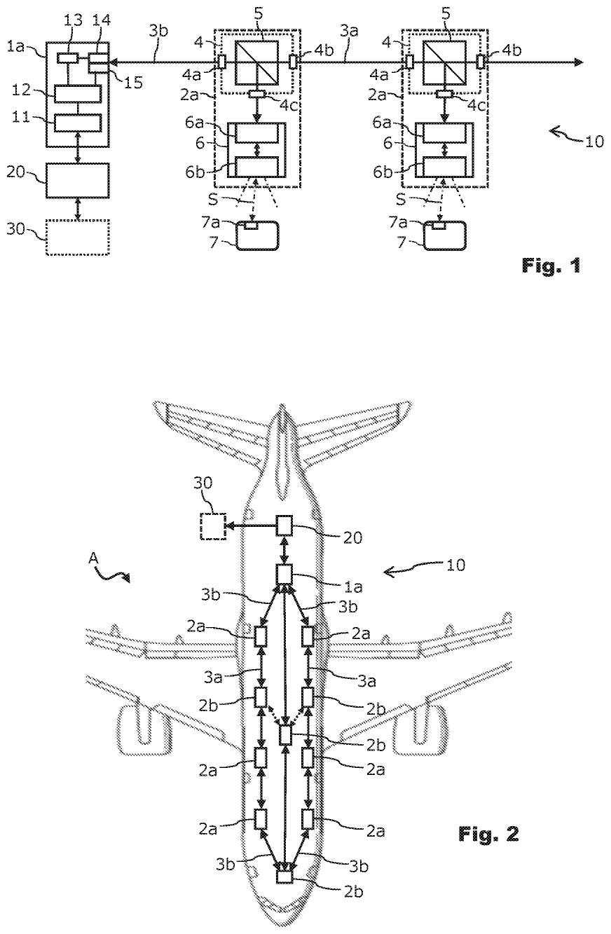

FIG. 1 shows an exemplary schematic illustration of an optical wireless communication network 10 as a block diagram. The optical wireless communication network 10 can, for example, be implemented in an aircraft, such as in the passenger aircraft A illustrated by way of example in FIG. 2.

A gateway router 1a that has a wireless radio connection or a wired connection to a network server 20 on board the aircraft A serves as a connection point to other external networks—indicated with reference sign 30 in FIGS. 1 and 2, without restriction to the generality—such as the Internet or a satellite network.

The gateway router 1a can receive and transmit digital data via a bidirectional data port 11. The bidirectional data port 11 has a communicative connection to a modulation/demodulation apparatus 12 of the gateway router 1a which is designed to encode digital data for feeding into the optical wireless communication network or to decode digital data received from the optical wireless communication network for forwarding to external networks 30. The modulation/demodulation apparatus 12 can use various modulation techniques for this purpose, such as single-carrier modulation techniques based on the deliberate variation of amplitude, frequency and/or phase of the light frequency that serves as the carrier. As an alternative to this, the modulation/demodulation apparatus 12 can employ multi-carrier modulation techniques such as orthogonal frequency division modulation (OFDM).

The modulation/demodulation apparatus 12 is coupled to a controllable light source 12 such as an LED or an OLED or a laser diode in the visible or near-infrared spectrum via a light source driver 13 on the one side, and to a photodetector 15, such as a photodiode, on the other side. The light source 14 and the photodetector 15 serve for physical data communication via optical data connections. The bidirectionality of the optical data connection can be implemented by using the light source 14 as a transmitter and the photodetector 15 as a receiver.

A large number of optical network nodes are connected downstream from the gateway router 1a. These network nodes can be designed as network nodes 2a according to the illustration in FIG. 1, or alternatively as network nodes 2b according to the illustration in FIG. 2. In general, each of the optical network nodes 2a, 2b comprises two optical network interfaces 4a and 4b. An optical signal transmission path extends between the two optical network interfaces 4a and 4b. A beam splitter 4 that can divert an optical signal to an optical access interface 4c of the beam splitter 4 is arranged along the optical signal transmission path. The beam splitter 4 can comprise suitable beam splitter components 5 for this purpose, for example a beam splitter plate, a beam splitter cube, a pentagon beam splitter, a pellicle beam splitter or a Köster prism. The beam splitter components 5 can here be formed of dichroic or non-dichroic materials. The beam splitter components 5 can, furthermore, have a polarizing or non-polarizing effect on the optical beams that pass through them.

The network nodes 2a or 2b further comprise an optical network access point 6 that is coupled to an optical access interface 4c of the beam splitter 4. The optical network access point 6 provides an inward or outward coupling point for network connections with optical end devices 7, meaning end devices 7 that have an optical network interface 7a by means of which optical wireless communication is possible.

The optical network access point 6 can, firstly, comprise an optical signal converter 6a with which the optical access interface 4c of the beam splitter 4 is coupled. This optical signal converter 6a can convert an optical signal from the beam splitter 4 into a drive signal for a downstream, controllable light source of the optical network access point 6. In the same way, the optical signal can 6a can receive digital signals from an end device 7 of a passenger of an aircraft A from a photodetector of the optical network access point 6 and feed them back via the beam splitter 4 into the optical wireless communication network. The controllable light source (e.g. an LED, an OLED or a laser diode in the visible or near-infrared spectrum) and the photodetector (e.g. a photodiode) can be implemented in a system 6b.

The system 6b can, in particular, be installed in aircraft A in a passenger service unit or in a ceiling or wall cladding panel of a passenger cabin of the aircraft A. In particular, wherever light sources are in any case installed for cabin lighting purposes or as reading lights, the implementation of additional access point functionality is opportune.

As illustrated in FIG. 2, a plurality of the optical network nodes 2a, 2b can be coupled together via optical free-space transmission paths 3a to form a bidirectional network connection. The connection to the gateway router 1a can be coupled via an optical free-space transmission path 3b to a last network node 2a, 2b in this type of chain of network nodes. The bidirectional network connections formed in this way between the gateway router 1a and the network nodes 2a, 2b can be configured here in different topologies. A full duplex ring topology, which in appropriate cases can pass via a network router 1b with amplifiers at opposite ends of the network ring, is shown by way of example in FIG. 2. Network nodes 2b can furthermore extend the ring topology to meshed-duplex topologies.

In an aircraft A, the optical free-space transmission paths 3a can advantageously run in cavities of interior cladding elements of the passenger cabin of the aircraft A to construct bidirectional network connections between the network nodes 2a or 2b distributed in the passenger cabin. The optical free-space transmission paths 3a are here largely protected against unwanted and undesired interferences. In addition, such cavities are protected against stray light and changing lighting conditions in the passenger cabin, whereby the optical data communication is more reliable and stable.

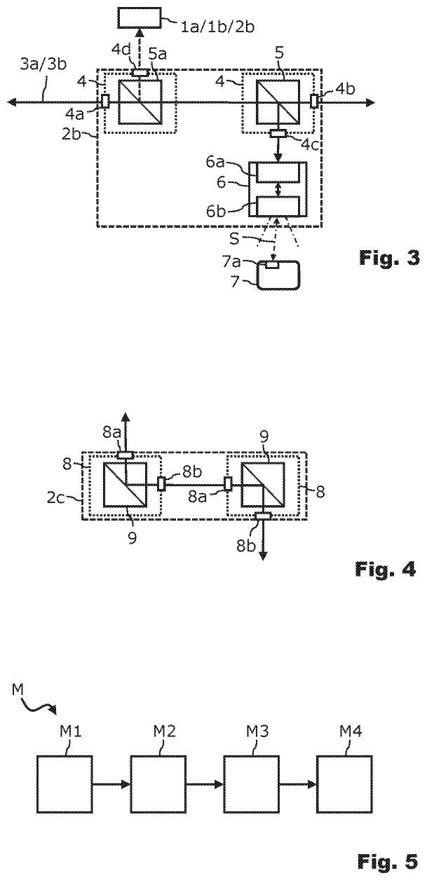

FIG. 3 shows a further variant of an optical network node 2b which comprises a further beam splitter 4 in addition to the elements of the network node 2a in FIG. 1. This beam splitter 4 is arranged in series with the first beam splitter 4, and has the purpose of providing a branching option to more of the large number of optical network nodes 2a, 2b or to a gateway router 1a via an optical network bifurcation interface 4d of the beam splitter 4.

If, as a result of external conditions in the aircraft A, a straight-line connection between two elements of the optical wireless communication network 10 is not possible, a periscope module 2c according to FIG. 4 can be employed. Such a periscope module 2a can guide the optical free-space transmission path 3a, 3b around corners, in that two beam splitters 8 are each arranged in an interconnected manner in the beam path of the optical free-space transmission path 3a, 3b via respective periscope interfaces 8a or 8b. The beam splitters 9 can also comprise beam splitter components 8 that can, for example, be a beam splitter plate, a beam splitter cube, a pentagon beam splitter, a pellicle beam splitter or a Köster prism. The beam splitter components 8 can here be formed of dichroic or non-dichroic materials. The beam splitter components 8 can, furthermore, have a polarizing or non-polarizing effect on the optical beams that pass through them.

FIG. 5 shows a method M for optical wireless communication in an aircraft. The method M can, for example, be applied in an aircraft A as illustrated in FIG. 2. The method M can here be implemented with the aid of the components of an optical wireless communication network 10 explained in connection with FIGS. 1 to 4 in an aircraft A, as sketched by way of example in FIG. 2.

As a first step M1, the method M comprises a formation of a bidirectional optical network connection via an optical free-space transmission path 3b between a gateway router 1a and a first of a large number of optical network nodes 2a, 2b. The gateway router 1a can for this purpose comprise a controllable light source 14, a photodetector 15 and a modulation/demodulation apparatus 12 coupled to the controllable light source 14 and the photodetector 15, so that there is an optical communication connection between a bidirectional interface of the gateway router 1a and a first of two optical network interfaces 4a, 4b of the respective first optical network node 2a.

In a second step M2, the bidirectional optical network connection is passed via an optical signal transmission path into the first optical network 2a, 2b from the first optical network interface 4a to a second optical network interface 4b. A beam splitter 4, which in a third step M3 can divide the bidirectional optical network connection to an optical network access point 6, is arranged along the optical signal transmission path. This network access point 6 is coupled for this purpose to an optical access interface 4c of the beam splitter 4.

To extend an optical wireless communication network 10, a bidirectional optical network connection can optionally be formed in a fourth step M4 via an optical free-space transmission path 3a between the second optical network interface 4b of the first optical network node 2a, 2b and a further optical network interface 4a, 4b of a second optical network node 2a, 2b.

In the preceding detailed description, various features were summarized in one or a plurality of samples to improve the cogency of the illustration. It should, nevertheless, be clear that the above description is merely illustrative, and is in no way of a restrictive nature. It serves to cover all the alternatives, modifications and equivalents of the various features and exemplary embodiments. Many other examples will become immediately and directly clear to the expert in the light of the above description as a result of his specialized knowledge.

The exemplary embodiments were selected and described in order to be able to illustrate the principles underlying the invention and their possible practical applications as effectively as possible. As a result, specialists are able to modify and use the invention and its various exemplary embodiments optimally with reference to the intended application. The terms “containing” and “comprising” in the claims and the description are used as linguistically neutral terminology for the corresponding term “including”. A use of the terms “a” or “an” furthermore does not fundamentally exclude a plurality of features and components described in that way.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An optical wireless communication network comprising:
a gateway router comprising a controllable light source, a photodetector and a modulation/demodulation apparatus coupled to the controllable light source and the photodetector; and
a large number of optical network nodes, each of which comprises:
an optical signal transmission path extending between a first and a second optical network interfaces of the optical network node;
at least one beam splitter arranged in the optical signal transmission path; and
an optical network access point coupled to an optical access interface of the beam splitter.

2. The optical wireless communication network according to claim 1, wherein the optical network access points each comprises:
an optical network signal converter coupled to the optical access interface of the beam splitter; and
a system including a controllable light source and a photodetector coupled to the optical signal converter.

3. The optical wireless communication network according to claim 1, wherein the at least one beam splitter comprises a beam splitter component selected from the group consisting of a beam splitter plate, a beam splitter cube, a pentagon beam splitter, a pellicle beam splitter and a Köster prism.

4. The optical wireless communication network according to claim 1, wherein at least two at a time of the large number of optical network nodes are coupled to one another via optical free-space transmission paths to construct a bidirectional network connection.

5. The optical wireless communication network according to claim 1, wherein the gateway router is coupled via an optical free-space transmission path to a first of the two optical network interfaces of one of the large number of optical network nodes to construct a bidirectional network connection.

6. The optical wireless communication network according to claim 1, wherein at least one of the large number of optical network nodes comprises:
at least two beam splitters arranged in the optical signal transmission path, wherein a first of the at least two beam splitters is coupled via an optical access interface to the optical network access point, and wherein a second of the at least two beam splitters is coupled via an optical network bifurcation interface of the beam splitter to a further one of the large number of optical network nodes or to a gateway router.

7. The optical wireless communication network according to claim 1, further comprising:
a network server coupled to the gateway router via a wireless radio network or a wired communication interface.

8. The optical wireless communication network according to claim 7, wherein the network server is configured to couple the gateway router to an external network.

9. The optical wireless communication network according to claim 1, wherein the large number of optical network nodes are optically coupled to one another in a full duplex ring topology or in a meshed full duplex topology.

10. An aircraft comprising an optical wireless communication network according to claim 1.

11. The aircraft according to claim 10, wherein the optical network access points of the large number of optical network nodes are installed in passenger service units or cladding panels of a passenger cabin of the aircraft.

12. The aircraft according to claim 10, wherein at least two of the large number of optical network nodes are coupled to one another via optical free-space transmission paths to form a bidirectional network connection, and the optical free-space transmission paths extend through cavities of interior cladding elements of the passenger cabin of the aircraft.

13. A method for optical wireless communication in aircraft, comprising:
forming a bidirectional optical network connection via an optical free-space transmission path between a gateway router comprising a controllable light source, a photodetector and a modulation/demodulation apparatus coupled to the controllable light source and the photodetector, and a first of two optical network interfaces of a first of a large number of optical network nodes;
passing the bidirectional optical network connection via an optical signal transmission path into the first of a large number of optical network nodes from the first of the two optical network interfaces to a second of the two optical network interfaces; and
dividing the bidirectional optical network connection by a beam splitter arranged in the optical signal transmission path to an optical network access point, which is coupled to an optical access interface of the beam splitter.

14. The method according to claim 13, further comprising:
forming a bidirectional optical network connection via an optical free-space transmission path between the second of the two optical network interfaces of the first of a large number of optical network nodes and an optical network interface of a second of the large number of optical network nodes.
